(19) United States
(12) Patent Application Publication
(10) Pub. No.: US 2026/0308029 A1
(43) Pub. Date: Oct. 8, 2026

(54) WATER TREATMENT METHOD AND WATER TREATMENT DEVICE

(71) Applicant: ORGANO CORPORATION, Tokyo (JP)

(72) Inventors: Mitsuya MORI, Tokyo (JP); Kyosuke YAMADA, Tokyo (JP); Masayuki KAWAKAMI, Tokyo (JP); Shohei YAMAMOTO, Tokyo (JP)

(73) Assignee: ORGANO CORPORATION, Tokyo (JP)

(21) Appl. No.: 19/478,569

(22) PCT Filed: Mar. 25, 2024
(86) PCT No.: PCT/JP2024/011713

§ 371 Date: Oct. 24, 2025

(30) Foreign Application Priority Data
Apr. 27, 2023 (JP) 2023-073509

(51) Int. Cl. C02F 1/76; C02F 1/00; C02F 1/44; C02F 1/68

(52) U.S. Cl. CPC C02F 1/766; C02F 1/008; C02F 1/441; C02F 1/686; C02F 2209/40; C02F 2209/44; C02F 2303/20

(57) ABSTRACT

A water treatment method includes obtaining permeated water and concentrated water by treating, by means of a reverse osmosis membrane, water to be treated to which a slime inhibitor containing an iodine-based oxidizing agent has been added. A water tank in which the water to be treated is stored exists between the addition point of the slime inhibitor and the reverse osmosis membrane. The slime inhibitor is added to the water to be treated by intermittent addition, and at least one of the addition concentration of the slime inhibitor, the addition time of the slime inhibitor, the flow rate of the water to be treated, and the volume of the water tank is adjusted such that the concentration of the slime inhibitor at the outlet of the water tank becomes 0.5 mg/L as Cl2 or more without changing the CT value of the slime inhibitor.

### TECHNICAL FIELD

The present invention relates to a water treatment method and a water treatment device for conducting a reverse osmosis membrane treatment using a slime inhibitor for the reverse osmosis membrane.

### BACKGROUND

In water treatments using a reverse osmosis membrane, slime generation can often causes problems.

Examples of known slime inhibitors for reverse osmosis membranes include chlorine-based oxidizing agents, bromine-based oxidizing agents, and iodine-based oxidizing agents and the like (for example, see Patent Documents 1 to 3).

In those cases where a fast-acting inorganic slime inhibitor is used, by adding the slime inhibitor using an intermittent addition method, costs can be suppressed compared with the case of continuous addition (see Patent Document 4).

In those cases where an intermittent addition method is used for addition of the slime inhibitor, and a water tank exists between the point of addition by the addition unit and the reverse osmosis membrane, the slime inhibitor is diluted in the water tank. When the slime inhibitor is diluted in a water tank, the slime suppression effect may sometimes not manifest satisfactorily. Although the slime suppression effect can be improved by increasing the added concentration of the slime inhibitor, this causes cost increases.

### CITATION LIST

### Patent Literature

Patent Document 1: JP 2006-263510 A
Patent Document 2: JP 2015-062889 A
Patent Document 3: WO 2021/192582 pamphlet
Patent Document 4: WO 2020/179789 pamphlet

### SUMMARY

### Technical Problem

An object of the present invention is to provide a water treatment method and a water treatment device which enable a superior slime suppression effect to be obtained while suppressing the amount used and the cost of the slime inhibitor.

### Solution to Problem

The present invention provides a water treatment method including a reverse osmosis membrane treatment step for obtaining a permeate and a concentrate by treating, with a reverse osmosis membrane, a water to be treated to which a slime inhibitor containing an iodine-based oxidizing agent has been added, wherein a water tank in which the water to be treated is stored exists between the addition point of the slime inhibitor and the reverse osmosis membrane, the slime inhibitor is added to the water to be treated by intermittent addition, and at least one of the addition concentration of the slime inhibitor, the addition time of the slime inhibitor, the flow rate of the water to be treated, and the volume of the water tank is adjusted such that the concentration of the slime inhibitor at the outlet of the water tank becomes at least 0.5 mg/L as Cl₂ without changing the CT value of the slime inhibitor.

It is preferable that the present invention includes a reverse osmosis membrane treatment step for obtaining a permeate and a concentrate by treating, with a reverse osmosis membrane, a water to be treated to which a slime inhibitor containing an iodine-based oxidizing agent has been added, wherein a water tank in which the water to be treated is stored exists between the addition point of the slime inhibitor and the reverse osmosis membrane, the slime inhibitor is added to the water to be treated by intermittent addition, and at least one of the addition concentration of the slime inhibitor, the addition time of the slime inhibitor, the flow rate of the water to be treated, and the volume of the water tank is adjusted such that a value f(T) determined from formula (1) shown below becomes 0.5 or greater.

$$\begin{matrix}[ Formula 1 ] & \\ f ( T ) = \frac{C ( V - F )}{1000 V} \{ 1 - {( 1 - \frac{F}{V} )}^{T + 1} \} & ( 1 )\end{matrix}$$

(In formula (1), C represents the addition concentration (mg/t as Cl₂) of the slime inhibitor, T represents the addition time (min) of the slime inhibitor, F represents the flow rate (t/min) of the water to be treated, and V represents the volume (t) of the water tank.)

In the above water treatment method, it is preferable that the CT value is within a range from at least 0.5 mg/L as Cl₂×min to not more than 20 mg/L as Cl₂×min, the addition concentration of the slime inhibitor is at least 0.7 mg/L as Cl₂, and the addition time of the slime inhibitor is not more than 30 minutes.

The present invention also provides a water treatment device including a reverse osmosis membrane treatment unit for obtaining a permeate and a concentrate by treating, with a reverse osmosis membrane, a water to be treated to which a slime inhibitor containing an iodine-based oxidizing agent has been added, a water tank which stores the water to be treated and is positioned between the addition point of the slime inhibitor and the reverse osmosis membrane, and a slime inhibitor addition unit for adding the slime inhibitor to the water to be treated by intermittent addition, wherein at least one of the addition concentration of the slime inhibitor, the addition time of the slime inhibitor, the flow rate of the water to be treated, and the volume of the water tank is adjusted such that the concentration of the slime inhibitor at the outlet of the water tank becomes at least 0.5 mg/L as Cl₂ without changing the CT value of the slime inhibitor.

It is preferable that the present invention includes a reverse osmosis membrane treatment unit for obtaining a permeate and a concentrate by treating, with a reverse osmosis membrane, a water to be treated to which a slime inhibitor containing an iodine-based oxidizing agent has been added, a water tank which stores the water to be treated and is positioned between the addition point of the slime inhibitor and the reverse osmosis membrane, and a slime inhibitor addition unit for adding the slime inhibitor to the water to be treated by intermittent addition, wherein at least one of the addition concentration of the slime inhibitor, the addition time of the slime inhibitor, the flow rate of the water to be treated, and the volume of the water tank is adjusted such that a value f(T) determined from formula (1) shown below becomes 0.5 or greater.

$$\begin{matrix}[ Formula 2 ] & \\ f ( T ) = \frac{C ( V - F )}{1000 V} \{ 1 - {( 1 - \frac{F}{V} )}^{T + 1} \} & ( 1 )\end{matrix}$$

(In formula (1), C represents the addition concentration (mg/t as Cl₂) of the slime inhibitor, T represents the addition time (min) of the slime inhibitor, F represents the flow rate (t/min) of the water to be treated, and V represents the volume (t) of the water tank.)

In the above water treatment device, it is preferable that the CT value is within a range from at least 0.5 mg/L as Cl₂×min to not more than 20 mg/L as Cl₂×min, the addition concentration of the slime inhibitor is at least 0.7 mg/L as Cl₂, and the addition time of the slime inhibitor is not more than 30 minutes.

### Advantageous Effects of Invention

The present invention is able to provide a water treatment method and a water treatment device which enable a superior slime suppression effect to be obtained while suppressing the amount used and the cost of the slime inhibitor.

### BRIEF DESCRIPTION OF DRAWINGS

FIG. 1 is a schematic structural diagram illustrating one example of a water treatment device according to an embodiment of the present invention.

FIG. 2 is a schematic structural diagram illustrating another example of a water treatment device according to an embodiment of the present invention.

### DESCRIPTION OF EMBODIMENTS

Embodiments of the present invention are described below. These embodiments are merely examples of implementing the present invention, and the present invention is not limited by these embodiments.

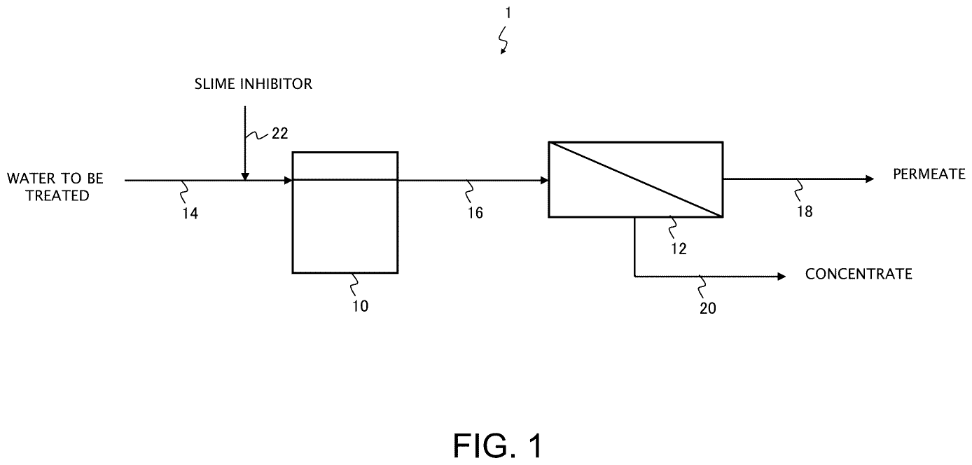

An outline of one example of a water treatment device according to an embodiment of the present invention is illustrated in FIG. 1, and the structure of that device is described below.

The water treatment device 1 illustrated in FIG. 1 includes a water tank 10 for storing the water to be treated, and a reverse osmosis membrane treatment device 12 which functions as a reverse osmosis membrane treatment unit for obtaining a permeate and a concentrate by treating, with a reverse osmosis membrane, the water to be treated to which a slime inhibitor containing an iodine-based oxidizing agent has been added.

In the water treatment device 1 in FIG. 1, a water to be treated line 14 is connected to a water to be treated inlet of the water tank 10. A water to be treated outlet of the water tank 10 and a water to be treated inlet of the reverse osmosis membrane treatment device 12 are connected by a water to be treated line 16. A permeate line 18 is connected to the permeate outlet of the reverse osmosis membrane treatment device 12, and a concentrate line 20 is connected to the concentrate outlet of the reverse osmosis membrane treatment device 12. A slime inhibitor addition line 22 is connected to the water to be treated line 14 as a slime inhibitor addition unit for adding a slime inhibitor to the water to be treated by the reverse osmosis membrane treatment.

Operations of the water treatment method and the water treatment device according to this embodiment are described below.

In the water treatment device 1, the water to be treated flows through the water to be treated line 14 and is fed into the water tank 10, and following storage, flows through the water to be treated line 16 and is fed into the reverse osmosis membrane treatment device 12. A slime inhibitor containing an iodine-based oxidizing agent is passed through the slime inhibitor addition line 22 and added to the water to be treated by the reverse osmosis membrane treatment in the water to be treated line 14 (a slime inhibitor addition step).

In the reverse osmosis membrane treatment device 12, the water to be treated containing the added slime inhibitor is treated by the reverse osmosis membrane, yielding a permeate and a concentrate (a reverse osmosis membrane treatment step). The permeate obtained in the reverse osmosis membrane treatment is discharged through the permeate line 18, and the concentrate is discharged through the concentrate line 20.

As a result of intensive investigation, the inventors of the present invention discovered that in a water treatment in which a reverse osmosis membrane treatment is conducted using a slime inhibitor containing an iodine-based oxidizing agent, and in which the water tank is positioned between the addition point of the slime inhibitor and the reverse osmosis membrane, and the slime inhibitor is added to the water to be treated by intermittent addition, by adjusting at least one of the addition concentration of the slime inhibitor, the addition time of the slime inhibitor, the flow rate of the water to be treated, and the volume of the water tank such that the concentration of the slime inhibitor at the outlet of the water tank becomes at least 0.5 mg/L as Cl₂ without changing the CT value (slime inhibitor addition concentration×addition time) of the slime inhibitor, a superior slime suppression effect could be obtained while suppressing the amount used and the cost of the slime inhibitor. By using this method, dilution of the slime inhibitor in the water tank can be suppressed, a satisfactory slime suppression effect can be obtained, and any cost increases can be suppressed.

At least one of the addition concentration of the slime inhibitor, the addition time of the slime inhibitor, the flow rate of the water to be treated, and the volume of the water tank may be adjusted such that the concentration of the slime inhibitor at the outlet of the water tank becomes at least 0.5 mg/L as Cl₂, and preferably 0.7 mg/L as Cl₂ or greater, without changing the CT value of the slime inhibitor in the water tank. If the concentration of the slime inhibitor at the outlet of the water tank is less than 0.5 mg/L as Cl₂, then the suppression effects on the amount used and the cost of the slime inhibitor may sometimes be unobtainable. Although there are no particular limitations on the upper limit for the concentration of the slime inhibitor at the outlet of the water tank, one example may be 20 mg/L as Cl₂.

Further, the inventors of the present invention also discovered that in a water treatment in which a reverse osmosis membrane treatment is conducted using a slime inhibitor containing an iodine-based oxidizing agent, and in which the water tank is positioned between the addition point of the slime inhibitor and the reverse osmosis membrane, and the slime inhibitor is added to the water to be treated by intermittent addition, by adjusting at least one of the addition concentration of the slime inhibitor, the addition time of the slime inhibitor, the flow rate of the water to be treated, and the volume of the water tank such that a value f(T) determined from formula (1) shown below becomes 0.5 or greater, a superior slime suppression effect could be obtained while suppressing the amount used and the cost of the slime inhibitor.

$$\begin{matrix}[ Formula 3 ] & \\ f ( T ) = \frac{C ( V - F )}{1000 V} \{ 1 - {( 1 - \frac{F}{V} )}^{T + 1} \} & ( 1 )\end{matrix}$$

(In formula (1), C represents the addition concentration (mg/t as Cl₂) of the slime inhibitor, T represents the addition time (min) of the slime inhibitor, F represents the flow rate (t/min) of the water to be treated, and V represents the volume (t) of the water tank.)

By using this method, dilution of the slime inhibitor in the water tank is suppressed, a satisfactory slime suppression effect can be obtained, and any cost increases are suppressed.

At least one of the addition concentration of the slime inhibitor, the addition time of the slime inhibitor, the flow rate of the water to be treated, and the volume of the water tank may be adjusted such that the value f(T) determined from the above formula (1) becomes 0.5 or greater, and preferably 0.7 or greater. If the value f(T) is less than 0.5, then the suppression effects on the amount used and the cost of the slime inhibitor may sometimes be unobtainable. Although there are no particular limitations on the upper limit for the value f(T), one example may be 20.

In the water treatment method and the water treatment device according to this embodiment, the CT value in the water tank is preferably within a range from at least 0.5 mg/L as Cl₂×min to not more than 20 mg/L as Cl₂×min, and more preferably within a range from at least 0.7 mg/L as Cl₂×min to not more than 10 mg/L as Cl₂×min. If the CT value is less than 0.5 mg/L as Cl₂×min, then a sterilization effect may not be obtainable, whereas if the CT value exceeds 20 mg/L as Cl₂×min, iodine may permeate through the reverse osmosis membrane.

The method used for adding the slime inhibitor to the water to be treated is intermittent addition, which includes an addition period during which the slime inhibitor is added to the water to be treated and a non-addition period during which the slime inhibitor is not added to the water to be treated. In other words, intermittent addition includes a step of adding the slime inhibitor to the water to be treated and supplying the water to be treated to the reverse osmosis membrane treatment device 12, and a step of supplying the water to be treated to the reverse osmosis membrane treatment device 12 without adding the slime inhibitor to the water to be treated. In contrast, continuous addition is a method in which the slime inhibitor is added continuously. The sterilizing power of a slime inhibitor containing an iodine-based oxidizing agent is extremely high, and a sterilization effect can be obtained in a very short time period, and therefore a satisfactory reverse osmosis membrane slime suppression effect can be achieved by adding the slime inhibitor containing an iodine-based oxidizing agent intermittently to the water to be treated.

It is preferable that the addition concentration of the slime inhibitor is 0.7 mg/L as Cl₂ or greater, and the addition time (addition period) of the slime inhibitor is not more than 30 minutes, and more preferable that the addition concentration of the slime inhibitor is 1.0 mg/L as Cl₂ or greater, and the addition time of the slime inhibitor is not more than 20 minutes. By adding the slime inhibitor to the water to be treated at a high concentration for a short period of time, dilution of the slime inhibitor in the water tank can be suppressed, a satisfactory slime suppression effect can be obtained, and any cost increases can be suppressed. Although there are no particular limitations on the upper limit for the addition concentration of the slime inhibitor, one example may be 200 mg/L as Cl₂. Although there are no particular limitations on the lower limit for the addition time of the slime inhibitor, one example may be 0.1 seconds. The non-addition time period may, for example, be set to a period within a range from 5 seconds to 320 hours.

For example, when the retention time in the water tank is 10 minutes, the addition concentration may be set to 0.7 mg/L as Cl₂ or greater and the addition time set to not more than 30 minutes, when the retention time is 30 minutes, the addition concentration may be set to 1.0 mg/L as Cl₂ or greater and the addition time set to not more than 20 minutes, and when the retention time is 60 minutes, the addition concentration may be set to 10 mg/L as Cl₂ or greater and the addition time set to not more than 2 minutes.

The effective iodine concentration in the water to be treated may be measured as either the total chlorine concentration or free chlorine concentration using a chlorine concentration measurement device, or may be calculated from the amount added through the pump used for adding the iodine-based oxidizing agent of a prescribed concentration.

The effective iodine concentration can be determined using the DPD (N,N-diethyl-p-phenylenediamine) method. DPD is oxidized by oxidizing agents, and examples of oxidizing agents that can be measured include chlorine, bromine, iodine, hydrogen peroxide, and ozone and the like. Chlorine forms that are quantified as total chlorine include all forms having oxidizing power, including hypochlorous acid, hypochlorite ions, chlorine, and combined chlorine such as chloramine and dichloramine. In a similar manner, all forms of bromine or iodine that have oxidizing power can be measured. Substances that are quantified as free chlorine include all forms that can be measured using the “total chlorine” measurement method (Section 33: Residual Chlorine in JIS K 0120:2013) without adding potassium iodide, and examples include hypochlorous acid, hypobromous acid, chlorine, bromine and iodine.

Further, “total chlorine” can be converted to “total iodine”. Specifically, a conversion may be made based on the “molecular weight of chlorine” and the “molecular weight of iodine”. In other words, “total chlorine”×(126.9/35.45×2)≈“total chlorine”×3.58=“total iodine”. In a similar manner, “free chlorine” can be converted to “free iodine”. When the effective iodine concentration is represented by as a total chlorine concentration equivalent value, the term “as Cl₂” is appended for clarity.

The addition concentration and addition time of the slime inhibitor may be adjusted, for example, by adjusting a pump or valve or the like installed in the slime inhibitor addition line 22 for adjusting the addition concentration, addition amount, and addition time and the like of the slime inhibitor. The flow rate of the water to be treated may be adjusting, for example, by adjusting a pump or the like used for adjusting the flow rate of the water to be treated into the water tank 10. The volume of the water tank may be set to the appropriate volume at the design stage for the water treatment device, or a water tank of different volume may be used as appropriate, or a water tank for which the volume may be changed as appropriate may be used.

The water treatment device 1 may include a control device which is used as a control unit for adjusting at least one of the addition concentration of the slime inhibitor, the addition time of the slime inhibitor, and the flow rate of the water to be treated.

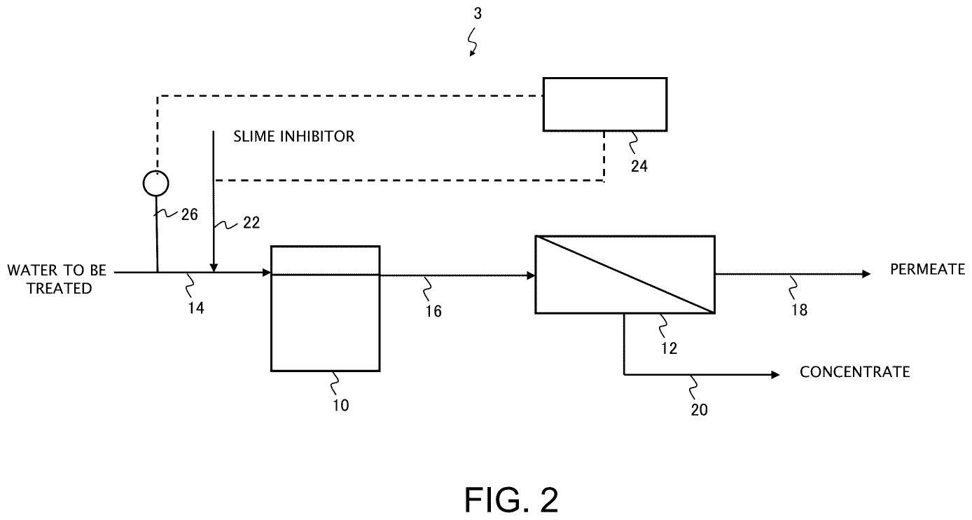

A water treatment device 3 illustrated in FIG. 2 has a control device 24 added to the structure of the water treatment device 1 of FIG. 1. The water treatment device 3 may also be provided with a flow rate meter 26 as a water flow rate measurement unit for measuring the flow rate of the water to be treated. The flow rate meter 26 is installed in the water to be treated line 14. Typically, “water tank 10 inlet flow rate=water tank 10 outlet flow rate”, and therefore the flow rate meter 26 may also be installed in the water to be treated line 16.

In the water treatment device 3, the control device 24 is connected, either through wiring or wirelessly, to enable communication with an adjustment unit (not shown in the drawing) such as a pump or valve or the like, which is provided in the slime inhibitor addition line 22 for adjusting the addition concentration, addition amount, and addition time and the like of the slime inhibitor, with the flow rate meter 26, and with a flow rate adjustment unit (not shown in the drawing) such as a pump or valve or the like for adjusting the flow rate of the water to be treated into the water tank 10. The control device 24 can control the adjustment unit and the flow rate adjustment unit to alter the addition concentration of the slime inhibitor, the addition time of the slime inhibitor, and the flow rate of the water to be treated such that the concentration of the slime inhibitor at the outlet of the water tank reaches at least 0.5 mg/L as Cl₂ without changing the CT value of the slime inhibitor.

The control device 24 is, for example, composed of a microcomputer comprising a processing unit such as a CPU that executes programs and memory units such as ROM and RAM that store programs and operational results, and electrical circuits and the like, and has the ability to control pump flow rates and the degree of opening of valves and the like.

The slime inhibitor used in the water treatment method and water treatment device according to embodiments of the present invention contains an iodine-based oxidizing agent.

An “iodine-based oxidizing agent” is an oxidizing agent containing iodine as an element, and may be an iodine compound that itself functions as an oxidizing agent, or may be a reaction product of an iodine compound and an oxidizing agent. Simple iodine (namely, I₂) also has oxidizing power, and therefore solutions containing simple iodine are also included within the definition of iodine-based oxidizing agents. The iodine incorporated as an element within the iodine-based oxidizing agent may be of any form, and may be one, or a combination, of molecular iodine, an iodide, a polyiodide, iodic acid, hypoiodous acid, hydrogen iodide, or iodine that is coordinated to an organic solvent such as polyvinylpyrrolidone or cyclodextrin. The method used for obtaining any of these forms of iodine may employ a method in which simple iodine is dissolved in a non-polar solvent such as benzene or carbon tetrachloride or an alcohol, a method in which simple iodine is dissolved using an alkali agent and water, or a method in which simple iodine is dissolved using an iodide salt and water, or total iodine may be obtained by adding an acid or an oxidizing agent to a solution containing at least one of an iodide salt and iodide ions. Furthermore, iodine that is coordinated to an organic solvent such as polyvinylpyrrolidone or cyclodextrin may be obtained using povidone-iodine which is composed of iodine coordinated to polyvinylpyrrolidone, a cyclodextrin-iodine inclusion compound which is composed of an inclusion of iodine in cyclodextrin, or an iodophor composed of iodine supported on an organic polymer or surfactant or the like.

From the viewpoints of ease of handling and having minimal effect on the water quality of the water to be treated and the treated water, the iodine-based oxidizing agent is preferably obtained by dissolving simple iodine using an iodide salt and water, without using any organic substances, namely, a solution containing water, iodine and an iodide. Simple iodine alone exhibits comparatively poor solubility in water, but dissolves in water in the presence of iodides or iodide ions. Further, a solution obtained by dissolving simple iodine using an iodide and water forms a stable single-liquid oxidizing agent with a comparatively high iodine concentration, and is easy to handle. The term “iodide” refers to iodine compounds with an oxidation number of −1. Examples of these iodides include potassium iodide, sodium iodide, lithium iodide, hydrogen iodide, silver iodide, copper iodide and zinc iodide. These iodides dissociate upon dissolution in water to form iodide ions.

In those cases where the iodine-based oxidizing agent is obtained as a reaction product of an iodine compound and an oxidizing agent, and examples of iodine compounds that may be used include potassium iodide, sodium iodide, lithium iodide, hydrogen iodide, silver iodide, copper iodide and zinc iodide, as well as mixtures of two or more of these compounds. From the viewpoint of cost and the like, the use of sodium iodide or potassium iodide as this iodine compound is preferred. The oxidizing agent that is reacted with the iodine compound is preferably an oxidizing agent having a higher oxidation-reduction potential (ORP) than that of iodine. Examples of oxidizing agents that may be used include combined chlorine and stabilized hypobromous acid compositions, although from the viewpoint of the rate of reaction and the like, an oxidizing agent of a form that can be detected as free chlorine is preferred. Representative examples of oxidizing agents having a form that can be detected as free chlorine include hypochlorous acid, hypobromous acid, and salts of these acids. A stabilized hypobromous acid composition is a composition containing a bromine-based oxidizing agent and a sulfamic acid compound, and may be a reaction product of a bromine-based oxidizing agent and a sulfamic acid compound, or a product obtained by reacting a sulfamic acid compound with the reaction product of a bromine compound and a chlorine-based oxidizing agent. Examples of the bromine-based oxidizing agent include simple bromine, bromine chloride, bromic acid, and bromate salts. In those cases where the iodine-based oxidizing agent is obtained as the reaction product of an iodine compound and an oxidizing agent, a slime inhibitor containing the iodine compound and the oxidizing agent may be added to the water to be treated, or the iodine compound and the oxidizing agent may be added separately to the water to be treated as slime inhibitors, with the iodine-based oxidizing agent then being produced within the water to be treated. Further, for example, the iodine compound may be added to a water to be treated already containing an oxidizing agent, such as a hypochlorous acid-containing water to be treated, and this case is also described as a “water to be treated to which a slime inhibitor containing an iodine-based oxidizing agent has been added”.

In those cases where the iodine-based oxidizing agent is an oxidizing agent prepared by using an iodide salt such as potassium iodide to dissolve iodine, namely in those cases where the oxidizing agent contains iodine and an iodide, from the viewpoint of the cost of the added chemicals, the molar ratio of the iodide (at least one of an iodide salt and iodide ions) relative to the iodine (namely, iodide (at least one of an iodide salt and iodide ions)/iodine) is preferably within a range from 1 to 1.9, more preferably from 1.5 to 1.9, and even more preferably from 1.8 to 1.9.

By using an iodide salt, the iodine becomes soluble in water and the like, but iodide salts are more expensive than iodine, and the higher the molar ratio of the iodide salt relative to iodine, the more the chemical costs increase, and therefore the molar ratio of the iodide relative to iodine is preferably kept low. However, if the molar ratio of the iodide relative to iodine is too low, then the total iodine yield (the total iodine value relative to the mixed iodine) decreases, and therefore a molar ratio at least as high as a prescribed value is preferably maintained.

From the viewpoint of stability and the like, the pH of the slime inhibitor is preferably at least 3 but not more than 9, more preferably at least 3 but not more than 7, and even more preferably at least 4 but not more than 6.5. If the pH falls to less than 3, then there is a possibility that the iodine may crystallize, whereas if the pH exceeds 9, there is a possibility of a dramatic reduction in the active ingredient. Further, if transport costs and the like for the slime inhibitor are also taken into consideration, then a high concentration and superior stability are preferred, and the total iodine concentration is preferably at least 3% by mass, more preferably within a range from at least 3% by mass to not more than 40% by mass, and even more preferably within a range from at least 10% by mass to not more than 25% by mass.

The pH of the water to be treated is preferably within a range from 2 to 12, and more preferably within a range from 4 to 9. If the pH of the water to be treated exceeds 9, then a decrease in the active ingredient causes a deterioration in the slime suppression effect, and if the pH exceeds 12, a satisfactory slime suppression effect may sometimes not be achievable, whereas if the pH is less than 2, crystals of iodine may precipitate, and a satisfactory slime suppression effect may sometimes not be achievable.

There are no particular limitations on the type of membrane used or the operating pressure in the reverse osmosis membrane used in the water treatment method and water treatment device of embodiments of the present invention, and operation may be conducted at any pressure that yields a permeate from the reverse osmosis membrane. For example, a salt water reverse osmosis membrane (low pressure reverse osmosis membrane) may be operated at a pressure of 0.2 to 1.2 MPa, a seawater desalination reverse osmosis membrane (high pressure reverse osmosis membrane) may be operated at a pressure of 3 to 5.5 MPa, and a seawater desalination reverse osmosis membrane (high pressure reverse osmosis membrane) may be operated for a salt water application at a pressure of 1.5 to 3.5 MPa.

Reverse osmosis membranes include neutral membranes, anionically charged membranes and cationically charged membranes, and any of these membrane types may be used.

In those cases where a widely used polyamide-based polymer membrane is used as the reverse osmosis membrane, the water treatment method and water treatment device of embodiments of the present invention can be implemented very favorably. Polyamide-based polymer membranes have comparatively low resistance to oxidizing agents, and if free chlorine or the like is kept in continuous contact with a polyamide-based polymer membranes, then a marked deterioration in membrane performance tends to occur. However, in a water treatment method in which a slime inhibitor containing an iodine-based oxidizing agent is added to the water to be treated, this type of marked deterioration in membrane performance is less likely, even for a polyamide-based polymer membrane.

When the reverse osmosis membrane is a polyamide-based reverse osmosis membrane, the chlorine content of the membrane surface of the reverse osmosis membrane is preferably at least 0.1 atom %, and is more preferably 0.5 atom % or greater. If the chlorine content of the membrane surface of the reverse osmosis membrane is less than 0.1 atom %, then the volume of permeate may sometimes decrease. The chlorine content of the reverse osmosis membrane surface can be measured by X-ray photoelectron spectroscopy.

The water to be treated by the reverse osmosis membrane treatment in the water treatment method and water treatment device according to embodiments of the present invention may be a water to be treated that contains organic matter, and may be a water to be treated that contains organic matter and nitrogen compounds. An example of a water to be treated containing organic matter is the treated water obtained from a wastewater treatment unit. The wastewater treatment unit may use any of a biological treatment, coagulation and settling, pressure flotation, sand filtration or biological activated carbon, or may use a combination of these techniques. The water to be treated may also include a biologically treated water obtained from a biological treatment unit (a biological treatment step).

It is thought that the water treatment method and water treatment device according to embodiments of the present invention will be particularly suited to wastewater recovery applications, such as the recovery of wastewater from the electronics industry, food production wastewater, beverage production wastewater, chemical plant wastewater, and plating plant wastewater and the like. In particular, water recovered from wastewater from the electronics industry often contains ammonia, and one example of a possible wastewater recovery flow is a flow having a water treatment device containing the reverse osmosis membrane treatment device 12, which utilizes the water treatment device and water treatment method according to embodiments of the present invention, located at a downstream stage from a biological treatment system containing a biological treatment device.

If necessary, a pretreatment step may be conducted prior to the reverse osmosis membrane treatment, and examples of this pretreatment step include biological, physical or chemical pretreatments such as biological treatments, coagulation treatments, coagulation and settling treatments, pressure flotation treatments, filtration treatments, membrane separation treatments, activated carbon treatments, ozone treatments and ultraviolet irradiation treatments, as well as combinations of two or more of these pretreatments.

In the water treatment device 1, in addition to the reverse osmosis membrane treatment device, other devices may also be provided if necessary, including a pump, safety filter, flow rate measurement device, pressure measurement device, temperature measurement device, oxidation-reduction potential (ORP) measurement device, residual chlorine measurement device, electrical conductivity measurement device, pH measurement device, and/or energy recovery device or the like.

In the water treatment device 1, if necessary, at least one substance selected from among slime inhibitors other than the slime inhibitor containing an iodine-based oxidizing agent, scale inhibitors, reducing agents and pH regulators may also be added to the water to be treated.

### EXAMPLES

The present invention is described below more specifically and in further detail using a series of examples and comparative examples, but the present invention is in no way limited by the following examples.

### Example 1, Comparative Example 1

### (Confirmation of Sterilization Effect)

Using an iodine-based oxidizing agent prepared by dissolving simple iodine using an iodide (potassium iodide) and water in the composition illustrated in Table 1 (Example 1) or a stabilized hypobromous acid composition prepared using the method described below (Comparative Example 1) as the slime inhibitor, the sterilization effect was compared. A simulated water was prepared by adding bouillon to Sagamihara well water that had undergone a dechlorination treatment to achieve a bacterial count between 10⁶ and 10⁷. The initial bacterial count (immediately prior to addition) and the bacterial count after a prescribed period of time had elapsed were measured. The bacterial count values were measured using a San-Ai Biochecker TTC (manufactured by San-Ai Obbli Co., Ltd.). The results are shown in Table 2 and Table 3.

### [Preparation of Stabilized Hypobromous Acid Composition]

Liquid bromine: 16.9 wt %, sulfamic acid: 10.7 wt %, sodium hydroxide: 12.9 wt %, potassium hydroxide: 3.94%, and water: the balance were mixed together under a nitrogen atmosphere to prepare a stabilized hypobromous acid composition. The pH of the stabilized hypobromous acid composition was 14, and the total chlorine concentration was 7.5 wt %. The total chlorine concentration represents the value (mg/L as Cl₂) measured by a total chlorine measurement method (the DPD (diethyl-p-phenylenediamine) method) using a multipurpose water quality analyzer DR/4000 manufactured by Hach Company. A more detailed description of the preparation method for the stabilized hypobromous acid composition is presented below.

A 2 L four-necked flask into which nitrogen gas was injected continuously at a flow rate controlled by a mass flow controller so that the oxygen concentration inside the reaction vessel was maintained at 1% was charged with 1,436 g of water and 361 g of sodium hydroxide, and following mixing, 300 g of sulfamic acid was added and mixed, and with the flask then cooled to maintain the temperature of the reaction solution at 0 to 15° C., 473 g of liquid bromine was added, and 230 g of a 48% solution of potassium hydroxide was then added, thus obtaining the target stabilized hypobromous acid composition containing 10.7 wt % of sulfamic acid and 16.9 wt % of bromine relative to the total weight of the composition, and having a ratio for the equivalent weight of sulfamic acid relative to the equivalent weight of bromine of 1.04. Measurement of the pH of the prepared solution using the glass electrode method yielded a value of 14. Measurement of the bromine content of the prepared solution using a method in which the bromine was substituted with iodine using potassium iodide, and a redox titration was then performed using sodium thiosulfate revealed a value of 16.9%, which was 100.0% of the theoretical content (16.9%). Further, the oxygen concentration inside the reaction vessel during the bromine reaction was measured using an “Oxygen Monitor JKO-02 LJDII” manufactured by Jikco Ltd. The bromate concentration was less than 5 mg/kg.

TABLE 1
Composition of iodine-based oxidizing agent

| Name of substance | Composition (%) |
|---|---|
| Water | 65.5 |
| Iodide | 20 |
| Iodine | 14.5 |

TABLE 2
Sterilization performance of iodine-based oxidizing agent

| Effective iodine | Initial | Bacterial | Bacterial |
|---|---|---|---|
| concentration | bacterial | count after | count after |
| (mg/L as Cl₂) | count | 10 minutes | 1 hour |
| 0.04 | 10\hat{ }7 | 10\hat{ }6 | 10\hat{ }6 |
| 0.05 | 10\hat{ }7 | 10\hat{ }5 | 10\hat{ }5 |
| 0.1 | 10\hat{ }7 | <10\hat{ }3 | <10\hat{ }3 |
| 0.2 | 10\hat{ }6 | <10\hat{ }3 | <10\hat{ }3 |
| 1.0 | 10\hat{ }7 | <10\hat{ }3 | <10\hat{ }3 |

TABLE 3
Sterilization performance of stabilized
hypobromous acid composition

| Total chlorine concentration | Initial bacterial | Bacterial count |
|---|---|---|
| (mg/L as Cl₂) | count | after 1 hour |
| 0.1 | 10\hat{ }6 | 10\hat{ }5 |
| 1.0 | 10\hat{ }6 | 10\hat{ }3 |

At effective iodine concentrations of 0.05 (mg/L as Cl₂) or higher, the iodine-based oxidizing agent exhibited a similar or better sterilization effect than the stabilized hypobromous acid composition. A particularly favorable sterilization effect was obtained when the effective iodine concentration in the water to be treated was 0.1 (mg/L as Cl₂) or higher.

### Example 2, Comparative Example 2

Under the test conditions described below, and using the iodine-based oxidizing agent of the composition shown in Table 1 as a slime inhibitor, the slime inhibitor concentration (effective iodine concentration) at the inlet to the water tank and the slime inhibitor addition time were altered appropriately as shown in Table 4, and the relationship between the effective iodine concentration (mg/L as Cl₂) at the inlet to the water tank, the slime inhibitor addition time (min), the effective iodine maximum concentration (mg/L as Cl₂) at the outlet of the water tank, and the calculated value for the effective iodine maximum concentration (mg/L as Cl₂) at the outlet of the water tank was investigated. The results are shown in Table 4. The treatment in which the iodine-based oxidizing agent was added at 7.5 mg/L as Cl₂ using an intermittent addition time of 1 minute, resulting in a maximum concentration at the water tank outlet of 0.78 mg/L as Cl₂ was deemed Example 2, and the treatment in which the iodine-based oxidizing agent was added at 0.75 mg/L as Cl₂ using an intermittent addition time of 10 minutes, resulting in a maximum concentration at the water tank outlet of 0.3 mg/L as Cl₂ was deemed Comparative Example 2.

Using a treatment in which the stabilized hypobromous acid composition was added continuously at an addition concentration of 0.23 mg/L as Cl₂ as a reference treatment, the values for the ratio of the time taken, in Example 2 and Comparative Example 2, for the water flow differential pressure to increase 10 kPa from the initial value relative to the reference treatment are shown in Table 5.

### [Test Conditions]

Device Configuration: the water treatment device illustrated in FIG. 1

### (Conditions in Water Tank)

Effective tank volume of water tank: Ø 3,000 mm×H 2,600 mm
Flow rate at water tank inlet: 54 t/h
Retention time: 20 min
Water to be treated line: 150 A
Slime inhibitor: an iodine-based oxidizing agent prepared by dissolving simple iodine using an iodide (potassium iodide) and water in the composition illustrated in Table 1 (Example 2, Comparative Example 2), or a stabilized hypobromous acid composition prepared using the method described above (the reference treatment)

### (Reverse Osmosis Membrane Treatment Conditions)

Reverse osmosis membrane: polyamide-based polymer membrane (a neutral membrane LFC3-LD-4040, manufactured by Nitto Denko Corporation)
Flow rate at inlet to reverse osmosis membrane treatment device: 750 L/h

TABLE 4

| | | | Calculated value |
|---|---|---|---|
| Effective | | Maximum | for maximum |
| iodine | Addition | concentration at | concentration |
| concentration | time | water tank outlet | at water tank outlet |
| (mg/L as Cl₂) | (min) | (mg/L as Cl₂) | (mg/L as Cl₂) |
| 7.5 | 1 | 0.78 | 0.69 |
| 3.8 | 2 | 0.42 | 0.51 |
| 2.5 | 3 | 0.43 | 0.44 |
| 1.9 | 4 | 0.37 | 0.40 |
| 1.5 | 5 | 0.36 | 0.38 |
| 0.75 | 10 | 0.30 | 0.31 |
| 0.5 | 15 | 0.26 | 0.27 |
| 0.38 | 20 | 0.23 | 0.23 |
| 0.30 | 25 | 0.21 | 0.21 |
| 0.25 | 30 | 0.19 | 0.19 |

The formula used for the calculation of the calculated value for the maximum concentration at the water tank outlet shown in Table 4 was formula (1) shown below. Further, converting formula (1) using V/F=HRT yields formula (2) shown below.

$$\begin{matrix}[ Formula 4 ] & \\ f ( T ) = \frac{C ( V - F )}{1000 V} \{ 1 - {( 1 - \frac{F}{V} )}^{T + 1} \} & ( 1 )\end{matrix}$$

$$\begin{matrix}[ Formula 5 ] & \\ f ( T ) = ( \frac{C}{1000} - \frac{C}{1000 HRT} ) \{ 1 - {( 1 - \frac{1}{HRT} )}^{T + 1} \} & ( 2 )\end{matrix}$$

In these formulas,
f(T)=maximum value for the effective iodine concentration (mg/L as Cl₂) at the water tank outlet
C: addition concentration (mg/t as Cl₂) of the slime inhibitor
T: addition time (min) of the slime inhibitor
F: flow rate (t/min) of the water to be treated
V: volume (t) of the water tank
HRT=retention time (min)

TABLE 5

| | Ratio of time taken for water flow |
|---|---|
| | differential pressure to increase |
| | 10 kPa from the initial value |
| | relative to reference treatment |
| Example 2 | 1.18 |
| Comparative Example 2 | 0.667 |

As shown in Table 5, in Example 2, although the CT value (amount of slime inhibitor used) did not differ from Comparative Example 2, a superior slime suppression effect was obtained.

### Example 3

Using the above formula (2), the relationship between the slime inhibitor addition concentration (mg/L as Cl₂), the addition time (min), the retention time (min), and the maximum concentration (mg/L as Cl₂) of the slime inhibitor at the water tank outlet was investigated using the CT values shown in Table 6 to Table 9. The results are shown in Table 6 to Table 9.

TABLE 6
CT of 7.5 mg/L as Cl₂ × min

| | Addition | Addition | Retention | Maximum |
|---|---|---|---|---|
| | concentration | time | time | concentration |
| | mg/L as Cl₂ | min | min | mg/L as Cl₂ |
| Example | 7.5 | 1 | 10 | 1.3 |
| Example | 3.8 | 2 | 10 | 0.9 |
| Example | 2.5 | 3 | 10 | 0.8 |
| Example | 1.9 | 4 | 10 | 0.7 |
| Example | 1.5 | 5 | 10 | 0.6 |
| Example | 0.8 | 10 | 10 | 0.5 |
| | 0.5 | 15 | 10 | 0.4 |
| | 0.4 | 20 | 10 | 0.3 |
| | 0.3 | 25 | 10 | 0.3 |
| | 0.3 | 30 | 10 | 0.2 |
| Example | 7.5 | 1 | 20 | 0.7 |
| Example | 3.8 | 2 | 20 | 0.5 |
| | 2.5 | 3 | 20 | 0.4 |
| | 1.9 | 4 | 20 | 0.4 |
| | 1.5 | 5 | 20 | 0.4 |
| | 0.8 | 10 | 20 | 0.3 |
| | 0.5 | 15 | 20 | 0.3 |
| | 0.4 | 20 | 20 | 0.2 |
| | 0.3 | 25 | 20 | 0.2 |
| | 0.3 | 30 | 20 | 0.2 |
| Example | 7.5 | 1 | 30 | 0.5 |
| | 3.8 | 2 | 30 | 0.4 |
| | 2.5 | 3 | 30 | 0.3 |
| | 1.9 | 4 | 30 | 0.3 |
| | 1.5 | 5 | 30 | 0.3 |
| | 0.8 | 10 | 30 | 0.2 |
| | 0.5 | 15 | 30 | 0.2 |
| | 0.4 | 20 | 30 | 0.2 |
| | 0.3 | 25 | 30 | 0.2 |
| | 0.3 | 30 | 30 | 0.2 |

TABLE 7
CT of 0.5 mg/L as Cl₂ × min

| | Addition | Addition | Retention | Maximum |
|---|---|---|---|---|
| | concentration | time | time | concentration |
| | mg/L as Cl₂ | min | min | mg/L as Cl₂ |
| Example | 16.7 | 0.03 | 10 | 1.5 |
| Example | 8.3 | 0.06 | 10 | 0.8 |
| Example | 5.6 | 0.09 | 10 | 0.5 |
| | 4.2 | 0.12 | 10 | 0.4 |
| | 3.3 | 0.15 | 10 | 0.3 |
| | 1.7 | 0.3 | 10 | 0.2 |
| | 1.1 | 0.45 | 10 | 0.1 |
| | 0.8 | 0.6 | 10 | 0.1 |
| | 0.7 | 0.75 | 10 | 0.1 |
| | 0.6 | 0.9 | 10 | 0.1 |
| Example | 16.7 | 0.03 | 20 | 0.8 |
| | 8.3 | 0.06 | 20 | 0.4 |
| | 5.6 | 0.09 | 20 | 0.3 |
| | 4.2 | 0.12 | 20 | 0.2 |
| | 3.3 | 0.15 | 20 | 0.2 |
| | 1.7 | 0.3 | 20 | 0.1 |
| | 1.1 | 0.45 | 20 | 0.1 |
| | 0.8 | 0.6 | 20 | 0.1 |
| | 0.7 | 0.75 | 20 | 0.1 |
| | 0.6 | 0.9 | 20 | 0.0 |
| Example | 16.7 | 0.03 | 30 | 0.6 |
| | 8.3 | 0.06 | 30 | 0.3 |
| | 5.6 | 0.09 | 30 | 0.2 |
| | 4.2 | 0.12 | 30 | 0.2 |
| | 3.3 | 0.15 | 30 | 0.1 |
| | 1.7 | 0.3 | 30 | 0.1 |
| | 1.1 | 0.45 | 30 | 0.1 |
| | 0.8 | 0.6 | 30 | 0.0 |
| | 0.7 | 0.75 | 30 | 0.0 |
| | 0.6 | 0.9 | 30 | 0.0 |

TABLE 8
CT of 20 mg/L as Cl₂ × min

| | Addition | Addition | Retention | Maximum |
|---|---|---|---|---|
| | concentration | time | time | concentration |
| | mg/L as Cl₂ | min | min | mg/L as Cl₂ |
| Example | 2.0 | 10 | 10 | 1.2 |
| Example | 1.0 | 20 | 10 | 0.8 |
| Example | 0.7 | 30 | 10 | 0.6 |
| | 0.5 | 40 | 10 | 0.4 |
| | 0.4 | 50 | 10 | 0.4 |
| | 0.2 | 100 | 10 | 0.2 |
| | 0.1 | 150 | 10 | 0.1 |
| | 0.1 | 200 | 10 | 0.1 |
| | 0.1 | 250 | 10 | 0.1 |
| | 0.1 | 300 | 10 | 0.1 |
| Example | 2.0 | 10 | 20 | 0.8 |
| Example | 1.0 | 20 | 20 | 0.6 |
| Example | 0.7 | 30 | 20 | 0.5 |
| | 0.5 | 40 | 20 | 0.4 |
| | 0.4 | 50 | 20 | 0.4 |
| | 0.2 | 100 | 20 | 0.2 |
| | 0.1 | 150 | 20 | 0.1 |
| | 0.1 | 200 | 20 | 0.1 |
| | 0.1 | 250 | 20 | 0.1 |
| | 0.1 | 300 | 20 | 0.1 |
| Example | 2.0 | 10 | 30 | 0.6 |
| Example | 1.0 | 20 | 30 | 0.5 |
| | 0.7 | 30 | 30 | 0.4 |
| | 0.5 | 40 | 30 | 0.4 |
| | 0.4 | 50 | 30 | 0.3 |
| | 0.2 | 100 | 30 | 0.2 |
| | 0.1 | 150 | 30 | 0.1 |
| | 0.1 | 200 | 30 | 0.1 |
| | 0.1 | 250 | 30 | 0.1 |
| | 0.1 | 300 | 30 | 0.1 |

TABLE 9
CT of 0.5 to 20 mg/L as Cl₂ × min, retention time of 60 minutes

| | Addition | Addition | Retention | Maximum |
|---|---|---|---|---|
| | concentration | time | time | concentration |
| | mg/L as Cl₂ | min | min | mg/L as Cl₂ |
| Example | 166.7 | 0.003 | 60 | 2.7 |
| Example | 83.3 | 0.006 | 60 | 1.4 |
| Example | 55.6 | 0.009 | 60 | 0.9 |
| Example | 41.7 | 0.012 | 60 | 0.7 |
| Example | 33.3 | 0.015 | 60 | 0.6 |
| | 16.7 | 0.03 | 60 | 0.3 |
| | 11.1 | 0.045 | 60 | 0.2 |
| | 8.3 | 0.06 | 60 | 0.1 |
| | 6.7 | 0.075 | 60 | 0.1 |
| | 5.6 | 0.09 | 60 | 0.1 |
| Example | 75.0 | 0.1 | 60 | 1.4 |
| Example | 37.5 | 0.2 | 60 | 0.7 |
| Example | 25.0 | 0.3 | 60 | 0.5 |
| | 18.8 | 0.4 | 60 | 0.4 |
| | 15.0 | 0.5 | 60 | 0.4 |
| | 7.5 | 1 | 60 | 0.2 |
| | 5.0 | 1.5 | 60 | 0.2 |
| | 3.8 | 2 | 60 | 0.2 |
| | 3.0 | 2.5 | 60 | 0.2 |
| | 2.5 | 3 | 60 | 0.2 |
| Example | 20.0 | 1 | 60 | 0.7 |
| Example | 10.0 | 2 | 60 | 0.5 |
| | 6.7 | 3 | 60 | 0.4 |
| | 5.0 | 4 | 60 | 0.4 |
| | 4.0 | 5 | 60 | 0.4 |
| | 2.0 | 10 | 60 | 0.3 |
| | 1.3 | 15 | 60 | 0.3 |
| | 1.0 | 20 | 60 | 0.3 |
| | 0.8 | 25 | 60 | 0.3 |
| | 0.7 | 30 | 60 | 0.3 |

Based on these results, it was evident that favorable results were achieved:
when the retention time was 10 minutes, the concentration of the slime inhibitor was at least 0.7 mg/L as Cl₂, and the addition time was not more than 30 minutes,
when the retention time was 30 minutes, the concentration of the slime inhibitor was at least 1.0 mg/L as Cl₂, and the addition time was not more than 20 minutes, and
when the retention time was 60 minutes, the concentration of the slime inhibitor was at least 10 mg/L as Cl₂, and the addition time was not more than 2 minutes.

At a CT value of 20 mg/L as Cl₂ or higher, there is a possibility that iodine may permeate the reverse osmosis membrane, and therefore this was deemed the maximum CT value, whereas based on the bacterial count effect observed after 10 minutes when the effective iodine concentration in Table 2 was 0.05 mg/L as Cl₂ or 0.1 mg/L as Cl₂, the minimum CT value was deemed to be 0.5 mg/L as Cl₂.

In this manner, by using the method of the examples, the amount used and the cost of the slime inhibitor was able to be suppressed, while achieving a superior slime suppression effect.

### REFERENCE SIGNS LIST

1, 3: Water treatment device
10: Water tank
12: Reverse osmosis membrane treatment device
14, 16: Water to be treated line
18: Permeate line
20: Concentrate line
22: Slime inhibitor addition line
24: Control device
26: Flow rate meter

1. A water treatment method comprising:
obtaining a permeate and a concentrate by treating, with a reverse osmosis membrane, a water to be treated to which a slime inhibitor containing an iodine-based oxidizing agent has been added, wherein
a water tank in which the water to be treated is stored exists between an addition point of the slime inhibitor and the reverse osmosis membrane,
the slime inhibitor is added to the water to be treated by intermittent addition, and
at least one of an addition concentration of the slime inhibitor, an addition time of the slime inhibitor, a flow rate of the water to be treated, and a volume of the water tank is adjusted such that a concentration of the slime inhibitor at an outlet of the water tank becomes at least 0.5 mg/L as Cl₂ without changing a CT value of the slime inhibitor.

2. A water treatment method comprising:
obtaining a permeate and a concentrate by treating, with a reverse osmosis membrane, a water to be treated to which a slime inhibitor containing an iodine-based oxidizing agent has been added, wherein
a water tank in which the water to be treated is stored exists between an addition point of the slime inhibitor and the reverse osmosis membrane,
the slime inhibitor is added to the water to be treated by intermittent addition, and at least one of an addition concentration of the slime inhibitor, an addition time of the slime inhibitor, a flow rate of the water to be treated, and a volume of the water tank is adjusted such that a value f(T) determined from formula (1) shown below becomes 0.5 or greater:
$$\begin{matrix}[ Formula 1 ] & \\ f ( T ) = \frac{C ( V - F )}{1000 V} \{ 1 - {( 1 - \frac{F}{V} )}^{T + 1} \} & ( 1 )\end{matrix}$$
(wherein in formula (1), C represents the addition concentration (mg/t as Cl₂) of the slime inhibitor, T represents the addition time (min) of the slime inhibitor, F represents the flow rate (t/min) of the water to be treated, and V represents the volume (t) of the water tank).

3. The water treatment method according to claim 1, wherein
the CT value is within a range from at least 0.5 mg/L as Cl₂×min to not more than 20 mg/L as Cl₂×min, the addition concentration of the slime inhibitor is at least 0.7 mg/L as Cl₂, and the addition time of the slime inhibitor is not more than 30 minutes.

4. A water treatment device comprising:
a reverse osmosis membrane for obtaining a permeate and a concentrate by treating, with the reverse osmosis membrane, a water to be treated to which a slime inhibitor containing an iodine-based oxidizing agent has been added,
a water tank which stores the water to be treated and is positioned between an addition point of the slime inhibitor and the reverse osmosis membrane, and
a slime inhibitor addition line for adding the slime inhibitor to the water to be treated by intermittent addition, wherein
at least one of an addition concentration of the slime inhibitor, an addition time of the slime inhibitor, a flow rate of the water to be treated, and a volume of the water tank is adjusted such that a concentration of the slime inhibitor at an outlet of the water tank becomes at least 0.5 mg/L as Cl₂ without changing a CT value of the slime inhibitor.

5. A water treatment device comprising: a reverse osmosis membrane for obtaining a permeate and a concentrate by treating, with the reverse osmosis membrane, a water to be treated to which a slime inhibitor containing an iodine-based oxidizing agent has been added,
a water tank which stores the water to be treated and is positioned between an addition point of the slime inhibitor and the reverse osmosis membrane, and
a slime inhibitor addition line for adding the slime inhibitor to the water to be treated by intermittent addition, wherein
at least one of an addition concentration of the slime inhibitor, an addition time of the slime inhibitor, a flow rate of the water to be treated, and a volume of the water tank is adjusted such that a value f(T) determined from formula (1) shown below becomes 0.5 or greater:
$$\begin{matrix}[ Formula 2 ] & \\ f ( T ) = \frac{C ( V - F )}{1000 V} \{ 1 - {( 1 - \frac{F}{V} )}^{T + 1} \} & ( 1 )\end{matrix}$$
(wherein in formula (1), C represents the addition concentration (mg/t as Cl₂) of the slime inhibitor, T represents the addition time (min) of the slime inhibitor, F represents the flow rate (t/min) of the water to be treated, and V represents the volume (t) of the water tank).

6. The water treatment device according to claim 4, wherein
the CT value is within a range from at least 0.5 mg/L as Cl₂×min to not more than 20 mg/L as Cl₂×min, the addition concentration of the slime inhibitor is at least 0.7 mg/L as Cl₂, and the addition time of the slime inhibitor is not more than 30 minutes.

7. The water treatment method according to claim 2, wherein
the CT value is within a range from at least 0.5 mg/L as Cl₂×min to not more than 20 mg/L as Cl₂×min, the addition concentration of the slime inhibitor is at least 0.7 mg/L as Cl₂, and the addition time of the slime inhibitor is not more than 30 minutes.

8. The water treatment device according to claim 5, wherein
the CT value is within a range from at least 0.5 mg/L as Cl₂×min to not more than 20 mg/L as Cl₂×min, the addition concentration of the slime inhibitor is at least 0.7 mg/L as Cl₂, and the addition time of the slime inhibitor is not more than 30 minutes.
